(19) United States
(12) Patent Application Publication
(10) Pub. No.: US 2005/0060670 A1
(43) Pub. Date: Mar. 17, 2005

(54) Automatic selection of screen saver depending on environmental factors

(75) Inventors: Takashi Inui, Yokohama-shi (JP); Seiichi Kawano, Sagamihara-shi (JP); Shinji Matsushima, Yokohama-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/936,128

(22) Filed: Sep. 8, 2004

(30) Foreign Application Priority Data
Sep. 8, 2003 (JP) 2003-315004

(51) Int. Cl. G06F 3/00

(52) U.S. Cl. 715/867; 715/747; 715/745; 715/764; 715/765; 715/767

(57) ABSTRACT

Provided is a method for automatically selecting a screen saver to display on a display device when no input has been made by a user of an information processing apparatus for a predetermined period of time. The selection may depend of any of several environmental factors of the apparatus, including; the power source, the location, the communication status or the types of devices attached to the apparatus.

### BACKGROUND

The present invention relates to method and associated apparatus and program for selecting a screen saver for an information processing apparatus. The present invention particularly relates to the selection of a screen saver to be operated for the purpose of screen protection and so on from among a plurality of screen savers, the selection depending on various environmental factors.

In recent years, as personal computers have become ubiquitous, screen savers, which display a user's favorite moving image or the like when no input has been made by a user for a predetermined period of time, have come to be widely used. Conventionally, a screen saver is uniformly activated when a predetermined period of time has elapsed. Accordingly, there have been occasions, which have caused inconvenience, when a screen saver is activated even in a case where a user does not intend to activate the screen saver.

As methods of controlling the activation of a screen saver while considering intentions of a user, for example, there have been proposed a method of controlling the activation of a screen saver depending on whether a specific application is activated (see Japanese published, unexamined patent application (PUPA) No. 2000-163034), a method of gradually indicating a time process until a screen saver is activated (see Japanese PUPA No. H10(1998)-161622), and a method of controlling the activation of a screen saver depending on whether or not a user is present near a computer (see Japanese PUPA No. H6(1994)-124188).

However, a technology described in the second listed PUPA above cannot control the activation itself of the screen saver although the technology can inform a user that activation time of the screen saver approaches. Moreover, a technology described in the third listed PUPA above requires a special device, which is rarely installed in an existing personal computer, although the technology can control the activation of the screen saver.

Moreover, a technology described in the first listed PUPA above can control the activation of the screen saver when a specific application is active. However, even when the same application is operated, it is sometimes desired to control the activation of the screen saver by other conditions.

Furthermore, the screen saver itself cannot be changed by any of the technologies described above. For example, when a portable personal computer is being driven by a battery, and when the remaining capacity of the battery is very little, there is a possibility that the capacity of the battery is soon used up if a screen saver is activated which displays a magnificent moving image thereon and consumes much electric power. Like this case, there are also many cases where control should be performed so as to change a screen saver itself.

### SUMMARY OF THE INVENTION

In this connection, it is an object of the present invention to provide a program, a recording medium, an information processing apparatus, and a selection method which are capable of solving the problems described above. This object is achieved by combinations of features described in independent claims of claims. Moreover, dependant claims prescribe further advantageous concrete examples of the present invention.

In order to solve the above-described problems, in a first aspect of the present invention, provided is a program for allowing an information processing apparatus to select a screen saver to display a predetermined image on a display device when no input has been made by a user for a predetermined period of time, the program allowing the information processing apparatus to function as: a power supply state detection unit for detecting a power supply state indicating which of an AC power supply or a battery the information processing apparatus is being driven by; and a screen saver selection unit for selecting a screen saver to be operated on the information processing apparatus among a plurality of screen savers depending on the power supply state. Moreover, a recording medium for recording the program, an information processing apparatus for selecting a screen saver by means of the program, and a selection method for selecting a screen saver by use of the information processing apparatus are provided.

Note that the above-described summary of the invention does not list all necessary features of the present invention, and subcombinations of groups of these features can also be incorporated in the invention.

According to the present invention, a screen saver can be selected appropriately.

### BRIEF DESCRIPTION OF THE DRAWINGS

For a more complete understanding of the present invention and the advantages thereof, reference is now made to the following description taken in conjunction with the accompanying drawings.

FIG. 1 is a block diagram showing an information processing apparatus 10.

FIG. 2 is a block diagram showing a central processing unit 1000.

FIG. 3 shows an operation flow of a program for allowing the information processing apparatus to select a screen saver.

FIG. 4 shows an operation flow following the flow of FIG. 3.

FIG. 5 shows details of an operation flow in S340 of FIG. 3.

FIG. 6 shows an operation flow following the flow of FIG. 5.

### DETAILED DESCRIPTION OF EMBODIMENTS OF THE PRESENT INVENTION

Hereinafter, the present invention will be described through one or more embodiments. However, the following embodiments are not intended to limit the present invention according to claims, and all combinations of features described in the embodiment are not necessarily essential to the solving means of the present invention.

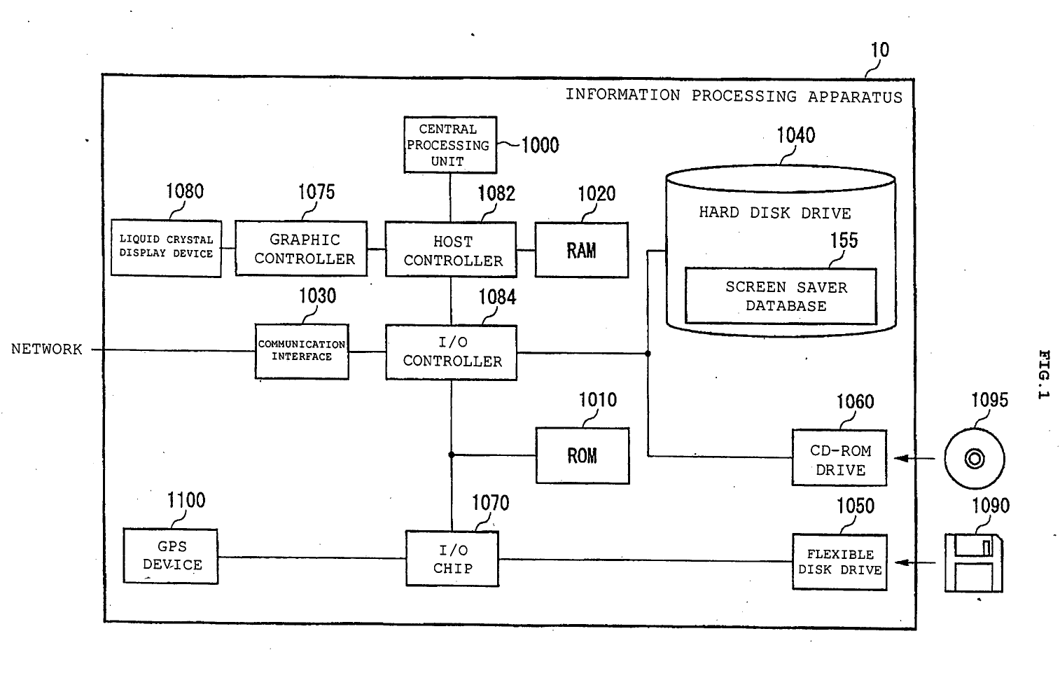

FIG. 1 is a block diagram of an information processing apparatus 10. The information processing apparatus 10 is an apparatus which selects a screen saver to be activated when no input has been made by a user for a predetermined period of time, depending on a state of a power supply and the like of the information processing apparatus 10. In this connection, an object here is to activate an appropriate screen saver depending on a state of the information processing apparatus 10 without requiring work of a user to change screen savers.

The information processing apparatus 10 includes a central processing unit peripheral section, an input/output section, and a legacy input/output section. The central processing unit peripheral section includes a central processing unit 1000, a RAM 1020, a graphic controller 1075, and a liquid crystal display device 1080, which are interconnected by a host controller 1082. The input/output section includes a communication interface 1030, a hard disk drive 1040, and a CD-ROM drive 1060, which are connected to the host controller 1082 by an input/output controller 1084. The legacy input/output section includes a ROM 1010, a flexible disk drive 1050, and an input/output chip 1070, which are connected to the input/output controller 1084.

The host controller 1082 interconnects the RAM 1020, the central processing unit 1000 accessing the RAM 1020 at a high transfer rate, and the graphic controller 1075. The central processing unit 1000 operates based on a program stored in the ROM 1010 and the RAM 1020 and controls each of the units. The graphic controller 1075 acquires image data created by the central processing unit 1000 and the like on a frame buffer provided in the RAM 1020, and displays an image from the image data on the liquid crystal display device 1080. Instead of this configuration, the graphic controller 1075 may include therein the frame buffer for storing the image data created by the central processing unit 1000 and the like.

The liquid crystal display device 1080 is a polarity-inversion liquid crystal display device which applies a potential periodically inverting its polarity to each of a plurality of elements changing their light transmissivity by being charged. Moreover, the liquid crystal display device 1080 has a backlight unit for irradiating a panel having a plurality of pixel elements arrayed thereon from a back of its display surface and for allowing irradiation light to be transmitted through the plurality of pixel elements. The input/output controller 1084 connects the host controller 1082 with the communication interface 1030, the hard disk drive 1040, and the CD-ROM drive 1060, which are relatively high-speed input/output devices. The communication interface 1030 communicates with an external device through a network of fiber channel or the like.

The hard disk drive 1040 stores programs and data for use in the information processing apparatus 10. For example, the hard disk drive 1040 functions as a screen saver database 155 for storing a plurality of screen savers. For example, the screen saver database 155 may store each of the screen savers in association with information indicating power consumption, average luminance of a display screen, an average display area of black on the entire display screen, and the like when the screen saver is operating. Moreover, the CD-ROM drive 1060 reads a program or data from a CD-ROM 1095 and provides the read program or data to the input/output chip 1070 through the RAM 1020.

The ROM 1010, and relatively low-speed input/output devices such as the flexible disk drive 1050 and the input/output chip 1070 are connected to the input/output controller 1084. The ROM 1010 stores a boot program to be executed by the central processing unit 1000 when activating the information processing apparatus 10, a program depending on hardware of the information processing apparatus 10, and the like. The flexible disk drive 1050 reads a program or data from a flexible disk 1090 and provides the read program or data to the input/output chip 1070 through the RAM 1020.

The input/output chip 1070 is connected to the flexible disk 1090, a GPS device 1100 and other input devices through, for example, a parallel port, a serial port, a keyboard port, a mouse port and the like. A program to be provided to the information processing apparatus 10 is stored in a recording medium such as the flexible disk 1090, the CD-ROM 1095 or an IC card and then provided by a user.

The program is read out of the recording medium through the input/output chip 1070 and/or the input/output controller 1084, installed in the information processing apparatus 10, and then executed. Moreover, the program may be stored in an external storage medium. As such a storage medium, besides the flexible disk 1090 and the CD-ROM 1095, an optical recording medium such as a DVD or a PD, a magneto-optical recording medium such as an MD, a tape medium, a semiconductor memory such as an IC card, and the like, are usable. Moreover, a storage device, such as a hard disk or a RAM, provided in a server system connected to a private communication network or the Internet is used as the recording medium, and thus the program may be provided to the information processing apparatus 10 through the network.

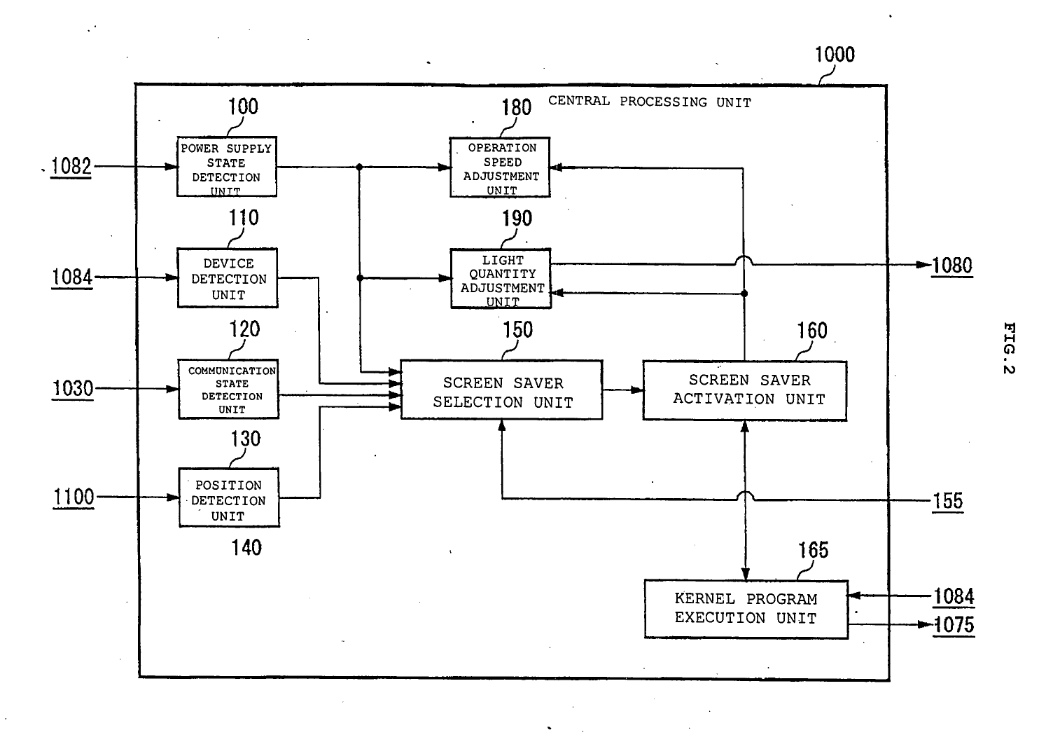

FIG. 2 is a block diagram of the central processing unit 1000. The program, installed in the information processing apparatus 10 to be executed, allows the central processing unit 1000 to function as a power supply state detection unit 100, a device detection unit 110, a communication state detection unit 120, a position detection unit 130, a screen saver selection unit 150, a screen saver activation unit 160, a kernel program execution unit 165, an operation speed adjustment unit 180, and a light quantity adjustment unit 190.

The power supply state detection unit 100 detects a power supply state indicating which of an AC power supply or a battery the information processing apparatus 10 is being driven by and indicating the remaining capacity of the battery, by means of the host controller 1082, for example. Then, the power supply state detection unit 100 sends the detected power supply state to the screen saver selection unit 150, the operation speed adjustment unit 180, and the light quantity adjustment unit 190. The device detection unit 110 detects information indicating a type of a device connected to the information processing apparatus 10, by means of the I/O controller 1084, for example, and sends the detected information to the screen saver selection unit 150.

The communication state detection unit 120 detects a communication state indicating whether or not it is possible for the information processing apparatus 10 to communicate with another device connected thereto through the network, by means of the communication interface 1030, for example. Then, the communication state detection unit 120 sends the detected communication state to the screen saver selection unit 150. In addition to this, the communication state detection unit 120 may detect, as the communication state, information indicating by which of wire or wireless communication the information processing apparatus 10 is connected to the network.

The position detection unit 130 detects a located position where the information processing apparatus 10 is located, by means of a GPS device 1100 and sends the detected position to the screen saver selection unit 150. Note that the power supply state detection unit 100, the device detection unit 110, the communication state detection unit 120, and the position detection unit 130 may detect the pieces of information indicating the power supply state, the type of the device, the communication state and the located position, respectively, by acquiring the respective pieces of information from the kernel program execution unit 165 or from a BIOS program stored in the ROM 1010.

Depending on the power supply state, the type of the device, the communication state, and the located position, the screen saver selection unit 150 selects a screen saver to be operated on the information processing apparatus 10 among the plurality of screen savers stored in the screen saver database 155 and sends the selected screen saver to the screen saver activation unit 160. For example, depending on which of the AC power supply or the battery the information processing apparatus 10 is being driven by, the screen saver selection unit 150 selects a screen saver in which information to be entered into the information processing apparatus 10 to close the screen saver concerned and return to a screen displayed before operating the screen saver concerned, is different from the other.

As an example, when the information processing apparatus 10 is being driven by the AC power supply, the screen saver selection unit 150 may select a screen saver which requires an input of a password to close the screen saver concerned. When being driven by the battery, the screen saver selection unit 150 may select a screen saver which does not require the input of the password to close the screen saver concerned. As still another example, when being driven by the AC power supply, the screen saver selection unit 150 may display a predetermined screen saver set by a user. When being driven by the battery, the screen saver selection unit 150 may display a screen saver which indicates the remaining capacity of the battery. Note that the screen saver is one displaying a predetermined moving or static image, and the predetermined image may include a case of displaying nothing, for example, a case of stopping the supply of power to the display device.

When it is detected by the I/O controller 1084 and the like that no input has been made by a user for a predetermined period of time, the kernel program execution unit 165 sends the screen saver activation unit 160 an instruction to the effect that the screen saver should be activated. Upon receiving the instruction to the effect that the screen saver should be activated from the kernel program execution unit 165, the screen saver activation unit 160 activates the screen saver received from the screen saver selection unit 150. Then, the screen saver activation unit 160 sends the moving image or the like of the screen saver concerned to the graphic controller 1075 through the kernel program execution unit 165. Moreover, the screen saver activation unit 160 notifies the operation speed adjustment unit 180 and the light quantity adjustment unit 190 that the screen saver has been activated.

Upon receiving the notice to the effect that the screen saver has been activated from the screen saver activation unit 160 when the power supply state received from the power supply state detection unit 100 indicates that the information processing apparatus 10 is being driven by the battery, the operation speed adjustment unit 180 lowers the operation speed of the central processing unit as compared with before the activation of the screen saver.

Upon receiving the notice to the effect that the screen saver has been activated from the screen saver activation unit 160 when the power supply state received from the power supply state detection unit 100 indicates that the information processing apparatus 10 is being driven by the battery, the light quantity adjustment unit 190 sends the liquid crystal display device 1080 a control signal for reducing the light from the backlight as compared with before the activation of the screen saver.

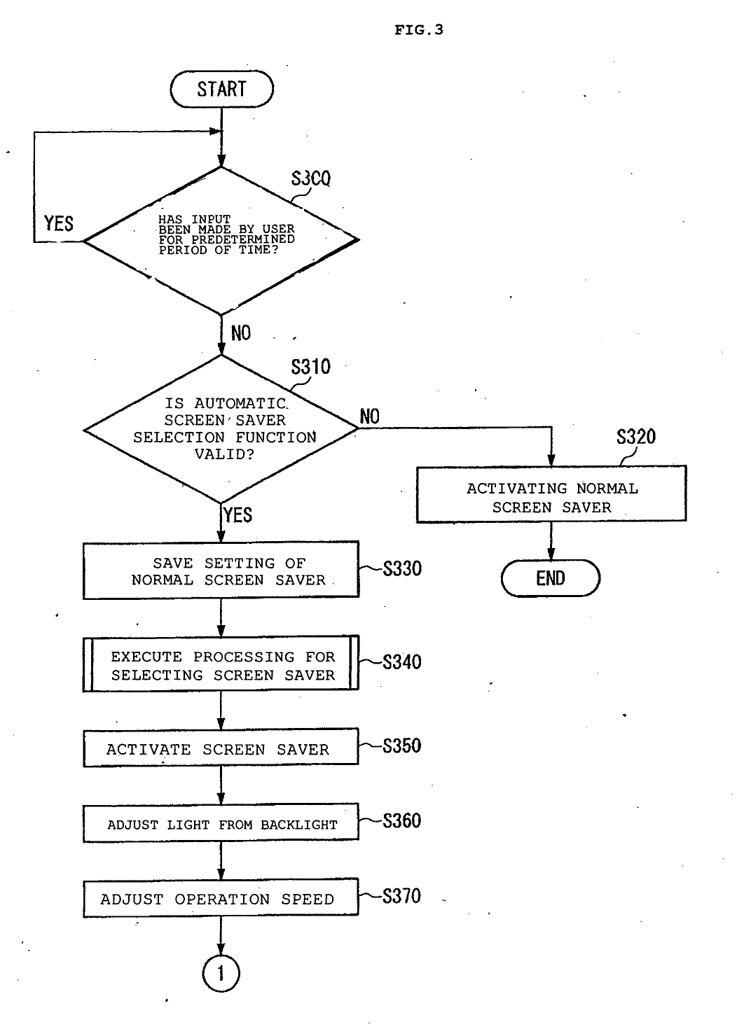

FIG. 3 shows an operation flow of the program for allowing the information processing apparatus 10 to select a screen saver. When no input has been made by a user for a predetermined period of time (S300: NO), the kernel program execution unit 165 determines whether or not an automatic screen saver selection function is valid (S310). When the automatic screen saver selection function is invalid (S310: NO), the kernel program execution unit 165 activates a normal screen saver (S320).

On the other hand, when the automatic screen saver selection function is valid (S310: YES), the kernel program execution unit 165 saves a setting regarding the normal screen saver (S330). Subsequently, the screen saver selection unit 150 executes processing for selecting a screen saver (S340). Details thereof will be described later. The screen saver activation unit 160 activates the selected screen saver (S350).

When the screen saver is activated in the case where the information processing apparatus 10 is being driven by the battery, the light quantity adjustment unit 190 reduces the light from the backlight as compared with before the activation of the screen saver (S360). Moreover, when the screen saver is activated in the case where the information processing apparatus 10 is being driven by the battery, the operation speed adjustment unit 180 lowers the operation speed of the central processing unit as compared with before the activation of the screen saver (S370).

For example, the operation speed adjustment unit 180 executes processing for transitioning to a CPU state in which power consumption is smaller as compared with before the activation of the screen saver, among a plurality of CPU states which are predetermined by the central processing unit 1000 and are mutually different in power consumption. Thus, the operation speed adjustment unit 180 may lower the operation speed of the central processing unit. Moreover, the operation speed adjustment unit 180 executes throttling processing for operating the CPU not continuously but intermittently and thus may lower the operation speed of the central processing unit. Instead of these, the operation speed adjustment unit 180 may lower the operation speed of a graphic accelerator provided in the graphic controller 1075.

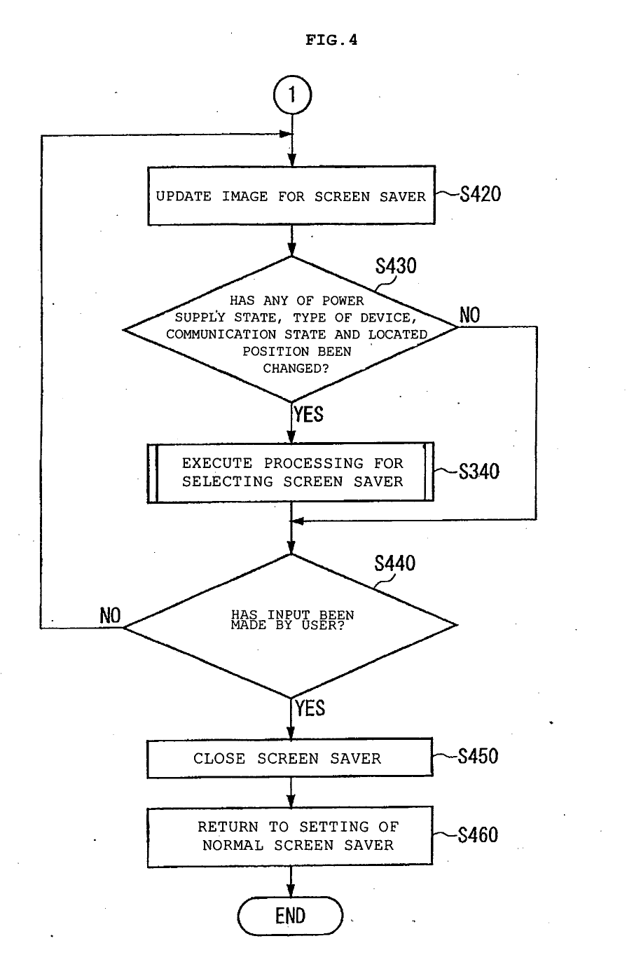

FIG. 4 shows an operation flow following the flow of FIG. 3. The screen saver activation unit 160 updates the image for the screen saver, for example, periodically (S420). When the power supply state, the type of the device, the communication state or the located position is changed (S430: YES), the screen saver selection unit 150 executes processing for selecting a screen saver (S430: YES). Thus, the screen saver selection unit 150 can select a screen saver appropriately not only when the screen saver is activated but also when the power supply state or the like of the information processing apparatus 10 is changed even while the screen saver is being operated.

Subsequently, when a keyboard or a mouse receives some input from a user (S440: YES), the kernel program execution unit 165 closes the screen saver and returns the information processing apparatus 10 to the screen displayed before the operation of the screen saver (S450). Note that, in a case where the screen saver is one which requires the input of the password, the kernel program execution unit 165 closes the screen saver when the input of a proper password is further received. Then, the kernel program execution unit 165 returns the setting to that regarding the normal screen saver, which has been saved in S330 (S460), and ends the processing. On the other hand, when the keyboard or the mouse receives no input from a user (S440: NO), the kernel program execution unit 165 returns the processing to S420.

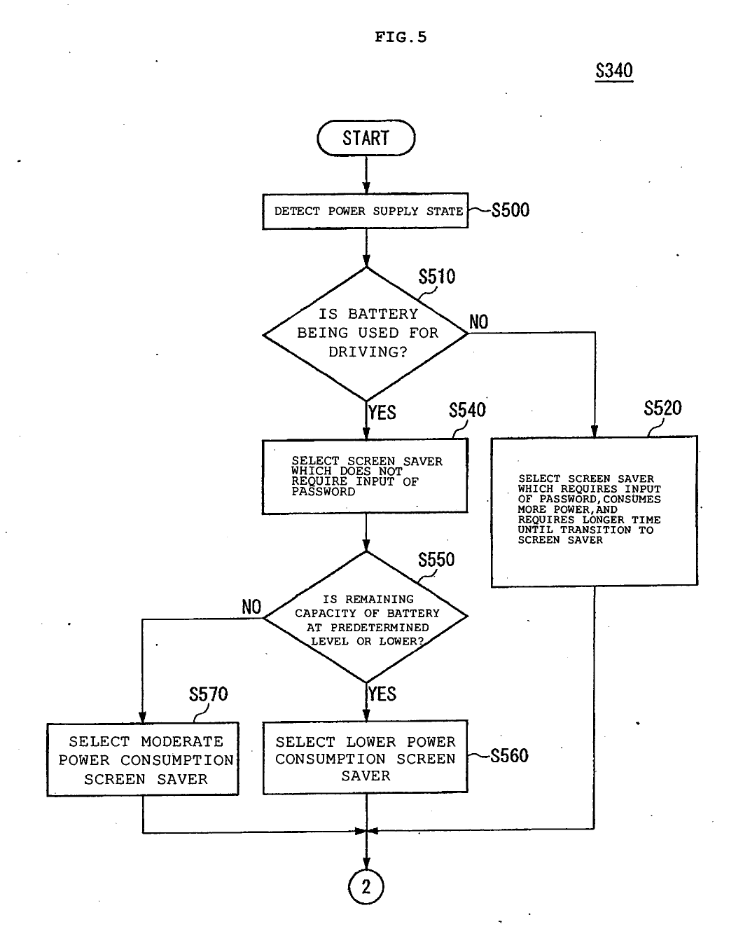

FIG. 5 shows details of an operation flow in S340 of FIG. 3. The power supply state detection unit 100 detects the power supply state (S500). When the information processing apparatus 10 is being driven by the AC power supply (S510: NO), the screen saver selection unit 150 selects a screen saver as described below (S520). This screen saver requires the input of a password to close and return to the screen displayed before the operation of the screen saver. Moreover, the screen saver requires a longer period from the latest input by a user until the screen saver starts operating as compared with the case where the information processing apparatus 10 is being driven by the battery. Furthermore, the screen saver increases power consumption per unit time of the information processing apparatus 10.

Here, a condition to determine whether or not the input of a password is required is not limited to the power supply state, but may be set according to other conditions and may be set according to a combination of the power supply state and other conditions. For example, when the information processing apparatus 10 is being driven by the AC power supply and connected to an expansion I/O device, the screen saver selection unit 150 may select the screen saver requiring the input of the password.

Moreover, the screen saver selection unit 150 may select a screen saver requiring a long time from the start of the operation of the screen saver until transition further to a power saving state thereof. For example, the screen saver selection unit 150 may select a screen saver requiring a long time from the start of the operation of the screen saver until transition to a monitor off state where a displaying function of the display device is turned off.

On the other hand, when the information processing apparatus 10 is being driven by the battery (S510: YES), the screen saver selection unit 150 selects a screen saver which does not require the input of a password to close the screen saver and return to the screen displayed before the operation of the screen saver (S540). In the case where the information processing apparatus 10 is being driven by the battery as described above, and therefore there is a high possibility that a user is carrying the information processing apparatus 10 and there is a low possibility that the information processing apparatus 10 is abused by others, the screen saver can be switched to one which does not require the input of a password. Thus, when the user starts operation, the display is immediately returned to a normal one without requiring the input of the password, and therefore the convenience is enhanced.

Instead of the above, on condition that the information processing apparatus 10 is being driven by the battery at both points of activating the screen saver and closing the screen saver, the screen saver selection unit 150 may select the screen saver which does not require the input of the password. Thus, protection by means of the password can be enhanced.

When the remaining capacity of the battery is at a predetermined level or lower (S550: YES), among the selected screen savers, the screen saver selection unit 150 selects a low power consumption screen saver which further reduces the power consumption per unit time of the information processing apparatus 10 as compared with the case where the remaining capacity of the battery is at a level more than the predetermined level (S560).

For example, as such a low power consumption screen saver, the screen saver selection unit 150 may select a screen saver which further lowers the average luminance of the display screen displayed by the liquid crystal display device 1080 of the information processing apparatus 10, a screen saver which further lowers a refresh rate of the liquid crystal display device 1080, or a screen saver which further reduces the number of lines scanning the plurality of pixels in the liquid crystal display device 1080. Moreover, as such a low power consumption screen saver, the screen saver selection unit 150 may select a screen saver which further increases the average display area of black on the entire display screen displayed by the liquid crystal display device 1080, a screen saver which further increases a cycle of polarity inversion of a potential to be applied to each element of the liquid crystal display device 1080, or a screen saver which further reduces resolution of a portion used for display in the liquid crystal display device 1080.

On the other hand, when the remaining capacity of the battery is at the level more than the predetermined level (S550: NO), the screen saver selection unit 150 selects a screen saver in which the power consumption per unit time is larger as compared with the case where the remaining capacity of the battery is at the predetermined level or lower, and is smaller as compared with the case where the information processing apparatus 10 is being driven by the AC power supply. That is, the screen saver selection unit 150 selects a screen saver in which the power consumption is moderate (S570).

Note that the selection of the screen saver includes not only the selection of a moving image to be displayed by the screen saver but also an article for selecting and setting information to be entered into the information processing apparatus 10 to close the screen saver. Specifically, for example, the screen saver selection unit 150 may select a screen saver to be operated on the information processing apparatus among a plurality of screen savers which have mutually different pieces of the information to be entered to close the screen savers, but display the same moving image.

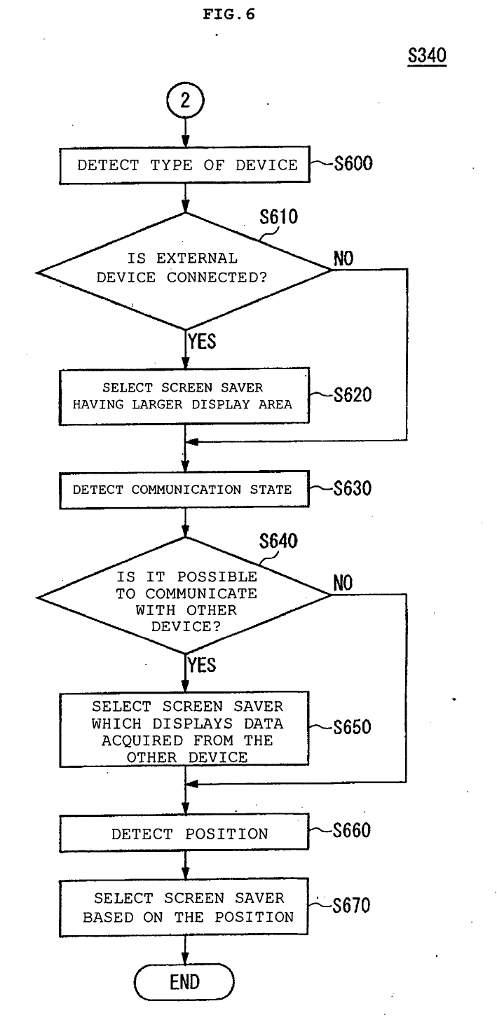

FIG. 6 shows an operation flow following the flow of FIG. 5. The device detection unit 110 detects the type of the device connected to the information processing apparatus 10 (S600). Then, based on the detected type of the device, the screen saver selection unit 150 selects a screen saver to be operated on the information processing apparatus 10 among the plurality of screen savers.

For example, when an external display is connected to the information processing apparatus 10 (S610: YES), the screen saver selection unit 150 selects a screen saver having a larger display area as compared with the case where the external device is not connected (S620). Thus, in a case where the information processing apparatus 10 is a notebook type personal computer and where resolution of the external display is higher than the resolution of the liquid crystal display device 1080, a suitable screen saver which effectively utilizes the resolution of the external display can be selected.

Moreover, when the expansion I/O device, for example, a device formed by integrally providing a plurality of I/O devices is connected to the information processing apparatus 10, there is a high possibility that the information processing apparatus 10 that is a portable information terminal is used while being fixedly placed and is being driven not by the battery but by the AC power supply. In such a case, the screen saver selection unit 150 may select a screen saver in which the consumption power per unit time is larger. Consequently, even if a screen saver desired by a user consumes more power than the other screen savers, the screen saver concerned can be appropriately selected.

Subsequently, the communication state detection unit 120 detects a communication state (S630). Then, based on the detected communication state, the screen saver selection unit 150 selects a screen saver to be operated on the information processing apparatus 10 among the plurality of screen savers. For example, when it is possible for the information processing apparatus 10 to communicate with another device connected to the network (S640: YES), the screen saver selection unit 150 selects a screen saver which displays data acquired from the other device (S650).

As an example, when it is possible for the information processing apparatus 10 to communicate with another device, the screen saver selection unit 150 selects a screen saver which displays stock price information distributed in real time from the other device. When it is not possible for the information processing apparatus 10 to communicate with another device, the screen saver selection unit 150 may select another screen saver which does not require information provided from the other device.

Subsequently, the position detection unit 130 detects position information indicating the position where the information processing apparatus 10 is located, by means of the GPS device 1100, for example (S660). Instead of this, the position detection unit 130 may detect the position information based on a device with which the information processing apparatus 10 communicates through the communication interface 1030. Then, based on the detected position information, the screen saver selection unit 150 selects a screen saver to be operated on the information processing apparatus 10 among the plurality of screen savers (S670). For example, when the detected position information coincides with a position of a living room of a user's home, the screen saver selection unit 150 may select a screen saver previously associated with the position, for example, a screen saver which displays a photograph of his/her family.

On the other hand, when the detected position information coincides with a position of a user's office, the screen saver selection unit 150 may select a screen saver previously associated with the position, for example, a screen saver which displays a geometric pattern. Thus, by previously setting desired screen savers for respective located positions, the user can selectively use the screen savers without changing the setting even when the user has moved the information processing apparatus 10.

In addition to the example shown in the drawings hereinbefore, the information processing apparatus 10 may select a screen saver depending on other environments. For example, the information processing apparatus 10 detects its own temperature and may select a screen saver different from others depending on the detected temperature. Thus, a person viewing the screen saver can be informed that the information processing apparatus 10 is overheating to fall in a dangerous state. Alternatively, a user can be entertained by displaying screen savers set in accordance with external temperatures.

As described above in this embodiment, the information processing apparatus 10 can select a screen saver, which is activated when no input has been made by a user for a predetermined period of time, depending on the power supply state and the like of the information processing apparatus 10. Thus, it is not necessary for a user to change the setting of the screen saver by him/herself, and accordingly, the convenience of the information processing apparatus 10 can be enhanced for the user.

Although the present invention has been described using the embodiment, the technical scope of the present invention is not limited to the scope described in the above embodiment. It is apparent for those skilled in the art that it is possible to add various alterations or modifications to the embodiment described above. It is apparent from descriptions of claims that modes with the addition of such alterations or modifications can also be incorporated in the technical scope of the present invention.

Although the preferred embodiment of the present invention has been described in detail, it should be understood that various changes, substitutions and alternations can be made therein without departing from spirit and scope of the invention as defined by the appended claims.

1. A method comprising:
detecting a power supply state of an information processing apparatus, said power supply state indicating whether said apparatus is currently receiving power from an A/C power supply or from a battery; and,
selecting, depending on said power supply state, a screen saver to activate when no input has been received from a user of said apparatus for a predetermined period of time, said screen saver being selected from among a plurality of available screen savers.

2. The method of claim 1 wherein, responsive to said power supply state indicating a battery power supply, said selecting comprises selecting a screen saver which does not require an input of a password to close the screen saver.

3. The method of claim 1 wherein, responsive to said power supply state indicating a battery supply state both when said selected screen saver is activated and when closure of said selected screen saver is initiated, no password is required to complete said closure.

4. The method of claim 1 wherein, responsive to said power supply state indicating a battery supply state, said selecting comprises selecting a screen saver which reduces power consumption of said apparatus as compared to a power consumption of said apparatus when said apparatus is being powered by an A/C power supply.

5. The method of claim 1 wherein, responsive to said power supply state indicating a battery supply state, said selecting comprises selecting a screen saver which allows an average light quantity output of a display of said apparatus to be reduced as compared to when said apparatus is being powered by an A/C power supply.

6. The method of claim 1 wherein, responsive to said power supply state indicating a battery supply state, said selecting comprises selecting a screen saver which allows a speed of operation of a central processing unit of said apparatus to be reduced as compared to when said apparatus is being powered by an A/C power supply.

7. The method of claim 1 wherein said predetermined period of time is set shorter when said power supply state indicates a battery supply state as compared to when said apparatus is being powered by an A/C power supply.

8. The method of claim 1 wherein, responsive to said power supply state indicating a battery supply state, the method further comprising determining a remaining battery capacity and wherein, responsive to said remaining battery capacity being less than a threshold, said selecting comprises selecting a low power consumption screen saver which further reduces power consumption of said apparatus as compared to when said remaining battery capacity is greater than said threshold.

9. The method of claim 8 wherein selecting a low power consumption screen saver comprises selecting a screen saver which reduces an average luminance of a display screen of said apparatus as compared to the average luminance of the display screen when said remaining battery capacity is greater than said threshold.

10. The method of claim 8 wherein selecting a low power consumption screen saver comprises selecting a screen saver which lowers a refresh rate of a display screen of said apparatus as compared to the refresh rate of the display screen when said remaining battery capacity is greater than said threshold.

11. The method of claim 8 wherein selecting a low power consumption screen saver comprises selecting a screen saver which increases an average display area of black on a display screen of said apparatus as compared to the display area of black on the display screen when said remaining battery capacity is greater than said threshold.

12. A method comprising:
detecting a communication state of an information processing apparatus, said communication state indicating whether said apparatus is currently capable of communication with other devices across a network; and,
selecting, depending on said communication state, a screen saver to activate when no input has been received from a user of said apparatus for a predetermined period of time, said screen saver being selected from among a plurality of available screen savers.

13. A method comprising:
detecting a location of an information processing apparatus; and,
selecting, depending on said location, a screen saver to activate when no input has been received from a user of said apparatus for a predetermined period of time, said screen saver being selected from among a plurality of available screen savers.

14. The method of claim 13 wherein said detecting is performed using global positioning satellite (GPS) technology.

15. A method comprising:
detecting one or more types of devices connected to an information processing apparatus; and,
selecting, depending on said one or more types of connected devices, a screen saver to activate when no input has been received from a user of said apparatus for a predetermined period of time, said screen saver being selected from among a plurality of available screen savers.

16. An information processing apparatus, comprising:
at least one central processing unit;
at least one display unit;
at least one memory unit;
an environment factor detection unit for detecting at least one factor associated with the current operating environment of said apparatus; and,
a screen saver selection unit for selecting, depending on said at least one environment factor, a screen saver to activate when no input has been received from a user of said apparatus for a predetermined period of time, said screen saver being selected from among a plurality of available screen savers stored in said at least one memory unit.

17. The apparatus of claim 16 wherein said at least one environment factor comprises a power supply state and said environment factor detection unit comprises a power supply state detection unit for detecting said power supply state of said apparatus, said power supply state indicating whether said apparatus is currently receiving power from an A/C power supply or from a battery.

18. The apparatus of claim 16 wherein said at least one environment factor comprises a communication state and said environment factor detection unit comprises a communication state detection unit for detecting said communication state of said apparatus, said communication state indicating whether said apparatus is currently capable of communication with other devices across a network.

19. The apparatus of claim 16 wherein said at least one environment factor comprises a location of said apparatus and said environment factor detection unit comprises a location detection unit for detecting said location of said apparatus.

20. The method of claim 19 wherein said location detection unit utilizes global positioning satellite (GPS) technology.

21. The apparatus of claim 16 wherein said at least one environment factor comprises one or more types of devices connected to said apparatus and said environment factor detection unit comprises a device detection unit for detecting said one or more types of connected devices.

22. A computer-readable medium having embodied thereon computer-readable program instructions effective when executing on a central processing unit of an information processing apparatus to:
detect a power supply state of said apparatus, said power supply state indicating whether said apparatus is currently receiving power from an A/C power supply or from a battery; and,
select, depending on said power supply state, a screen saver to activate when no input has been received from a user of said apparatus for a predetermined period of time, said screen saver being selected from among a plurality of available screen savers.
